(19) United States
(12) Patent Application Publication
(10) Pub. No.: US 2010/0061912 A1
(43) Pub. Date: Mar. 11, 2010

(54) Apparatus for high temperature hydrolysis of water reactive halosilanes and halides and process for making same

(76) Inventor: Stephen Michael Lord, Encinitas, CA (US)

Correspondence Address: STEPHEN MICHAEL LORD, 109 PEPPERTREE LANE, ENCINITAS, CA, 92024, US

(21) Appl. No.: 12/283,077

(22) Filed: Sep. 8, 2008

(51) Int. Cl. C01B 33/021; C01B 33/107; B01J 8/24

(52) U.S. Cl. 423/342; 423/349; 422/145; 422/140

(57) ABSTRACT

A process for high temperature hydrolysis of halosilanes and halides with the steps of: providing a bed of fluidized particulate material heated to at least 300° C., injecting steam and an excess of reactants into the reactor, removing solid waste from a bottom outlet, removing the effluent gases through a solids removal device such as a cyclone, condensing and separating some of the unreacted waste from the effluent gas in a distillation column and sending the effluent gases containing hydrogen and hydrogen chloride to a compressor. In a preferred embodiment the reactants contain at least one water reactive halide, selected from the group halosilane, organohalosilane, aluminum halide, titanium halide, boron halide, manganese halide, copper halide, iron halide, chromium halide, nickel halide, indium halide, gallium halide and phosphorus halide and where the halide content is selected from chlorine, bromine and iodine.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of silicon purification and more specifically to an apparatus and a process for high temperature, greater than 300° C., hydrolysis of water reactive halosilanes and halides produced during silicon purification. It is desirable to recover the halogen content for reuse as the halogen is the bulk of the mass and easily reused and the metals come from the feedstock MGS silicon and have little value. Also disposal of this waste is difficult as the ingredients react with air and water to form hydrohalide acid gases and the hydrolysis residue still contains some halide content which makes disposal more difficult. As noted above the metal content of the waste may be used to generate a hydrohalide gas and this is of particular value as hydrogen is lost in the process via leaks and deliberate vents. Thus a desirable process would recover almost all of the halogen and hydrogen needed to run the process and provide a hydrolysis residue low in chlorides which can be sent to a non-hazardous waste dump thus reducing operating cost.

In order to reuse the hydrohalide gas directly in the silicon purification process it must be very dry as any water reacts to form silica inside the process and unfortunately hydrohalides form azeotropes with water so conventional distillation can not separate them. The production of the hydrohalide aqueous acid is technically feasible but it has such low value it would not significantly offset the cost of purchase of the make-up halogen and hydrogen.

With the increasing demand for silicon based photovoltaic systems, it is desirable to reduce the cost of producing the purified silicon needed and the environmental impact of the wastes from the purification plant. The purification plants are usually based on chlorine chemistry but essentially similar plants based on other halogens such as bromine and iodine are also feasible and produce similar wastes although there are some important differences in their properties. The term halogens is used to refer to chlorine, bromine or iodine but not fluorine and similarly halides refer to the salts of these halogens and halosilanes refer to the range of silicon compounds feasible with these halogens which also include compounds containing oxygen and hydrogen in addition to silicon and the halogen. The term organohalosilanes is a subset of halosilanes that also contain organic groups such as methyl, CH3, ethyl, C2H5 and a wide range of others.

In order to reduce costs and environmental impacts, it is important to recycle as much of the chemicals used to purify the silicon as possible. These chemicals are made by the addition of a halogen containing material, typically chlorine, although bromine and iodine are possible, and hydrogen to metallurgical grade silicon containing impurities which need to be removed. This reaction causes the production of volatile halosilanes and some volatile halides which leave the reactor as gases and leave behind other impurities mixed with the residual silicon. Most of the halosilanes and volatile halides are then condensed and separated from the non-condensable gases, primarily hydrogen with some hydrogen chloride, which are recycled although there are also losses of hydrogen and other gases from leaks at piston compressors, flanges, and valves and deliberate purges required to prevent buildup of impurities.

The main wastes are from purification of the halosilanes, typically chlorosilanes, used to make a high purity halosilane for conversion to high purity silicon. These halosilane wastes consist of metal and non-metal halides, dissolved and suspended in a halosilane fluid together with some solid silicon carried over from the initial reaction. The bromosilane and iodosilane wastes have a lower volatility than the chlorosilanes and less suspended solids, because the bromide and iodide of aluminum are much more soluble in their respective halosilanes than the aluminum chloride is in chlorosilanes. While the halosilanes and metal halides are toxic and reactive, the oxides and hydroxides of silicon and the other impurities are environmentally benign. Thus it is desired to provide an oxygen based waste. This can be produced by reacting the waste with oxygen or water. The former will produce the oxide plus the elemental halogen and the hydrohalide and the latter will produce the oxide and/or hydroxide and the hydrohalide only. Producing the hydrohalide has the advantage of producing a material with hydrogen content to offset the hydrogen losses noted above and which is easily recycled directly back to the initial reaction.

It is further desirable to have low energy costs to reduce cost and environmental impacts thus a self-sustaining reaction which directly produces a dry oxide waste is desirable as it avoids the input of heat energy for the reaction and for drying the waste.

The prior art has only concerned itself with processing chlorosilane waste which is more prevalent than bromosilane or iodosilane waste.

Initial work by Breneman U.S. Pat. No. 4,743,344 consisted primarily of recovering chlorosilanes by evaporation from slurries. It does mention the disposal of “light impurities” which are flared to a burner. The concentrated heavies are neutralized or combusted with kerosene.

There is also a patent by Feldner U.S. Pat. No. 4,758,352 which is for high boiling solids and copper containing waste from organochlorosilane synthesis. This not directly applicable to waste from halosilane synthesis because halosilanes are considered inorganic compounds as they do not contain organic groups. Furthermore the process to make organochlorosilanes has a much higher copper content in the silicon-copper reacting mass than in the inorganic halosilane process. Not surprisingly, this process focuses on recovering copper. The process uses liquid phase hydrolysis and oxidation to produce a slurry which is then filtered and dried. The recovery of copper shows one of the problems of any liquid phase based hydrolysis which is that there is soluble copper in the liquid. If this copper is not recovered then it remains in the water and copper containing water cannot be discharged to navigable waterways because it is extremely poisonous to fish.

Ruff has four patents: U.S. Pat. No. 5,066,472, U.S. Pat. No. 5,080,804, U.S. Pat. No. 5,246,682 and U.S. Pat. No. 5,252,307

Ruff U.S. Pat. No. 5,066,472 uses hydrolysis with water vapor between 100° C.-300° C. with additional hydrogen chloride to produce hydrogen chloride and azeotropic hydrochloric acid.

Ruff U.S. Pat. No. 5,080,804 is a neutralization process using calcium carbonate which locks up the chlorine as calcium chloride and can pass EPA leach tests. Other calcium compounds such as lime could be used for the same purpose.

Ruff U.S. Pat. No. 5,246,682 follows on his previous patent but eliminates the production of hydrochloric acid and produces a lower chloride, 6%, waste which can be stored or an even lower 1% chloride waste.

Ruff U.S. Pat. No. 5,252,307 continues the previous work but restricts it to starting at temperature below 160° C. and finishing with a temperature over 170° C.

Breneman Application US 2006/0183958

Follows his previous patent by evaporating the chlorosilanes then neutralizing the residual solid waste with sodium carbonate or bicarbonate in a manner directly analogous to the use of calcium carbonate by Ruff U.S. Pat. No. 5,080,804.

A major deficiency is that the prior art has only concerned itself with processing chlorosilane waste which is more prevalent than bromosilane waste but has somewhat different properties. Further deficiencies have been failure to recover the valuable halogen content in a directly usable form, production of high residual chlorine content waste and a large use of energy.

The initial work by Breneman U.S. Pat. No. 4,743,344 required significant extra heat for recovering chlorosilanes by evaporation from slurries, for disposal of “light impurities” which are flared to a burner and for combusting the concentrated heavies. The suggested alternative of neutralizing the heavies would also require energy for drying the sludge. There is no attempt to recover the chlorine content of the waste halides.

Ruff attempts to recover the waste halides as hydrogen halide, specifically hydrogen chloride, but is forced to produce hydrochloric acid also which is not useable directly in the process and must be recycled and evaporated again within his process. His initial process U.S. Pat. No. 5,066,472 also produces a high chloride content waste. Some of the faults of this process are corrected in a later patent U.S. Pat. No. 5,246,682 which eliminates the net production of hydrochloric acid and produces a lower chloride, 6%, waste which can be stored or an even lower 1% chloride waste. He also has another patent U.S. Pat. No. 5,080,804 which produces better quality waste but does not recover the halogen content and produces carbon dioxide.

More specifically, Ruff U.S. Pat. No. 5,066,472 uses hydrolysis with water vapor between 100° C.-300° C. with additional hydrogen chloride and Ruff U.S. Pat. No. 5,246,682 follows on his previous patent but claims to eliminate the net production of hydrochloric acid and produces a lower chloride, 6%, waste which can be stored or an even lower 1% chloride waste. In both cases he uses a steam or drying/heat treatment step at a temperature below 300° C. which is part of the reason he cannot get a high enough reaction rate to produce a low residual chlorine content. In the second patent he introduces an initial step of reacting the waste in liquid hydrochloric acid at room temperature which generates a hydrogen chloride and water vapor effluent which he condenses and recycles to the first step. It is claimed that dry hydrogen chloride is produced by condensation of a water rich phase but this is known to be physically impossible as hydrochloric acid forms an azeotrope where the liquid and vapor phase composition are the same therefore no enrichment is possible. Thus it seem that dilute hydrochloric acid is used to produce a more concentrated hydrochloric acid but this acid is not directly reusable in the process; it is also possible that there is a desorption/adsorption column as mentioned in Ruff U.S. Pat. No. 5,066,472 that can produce hydrogen chloride gas and azeotropic hydrochloric acid. In Ruff U.S. Pat. No. 5,066,472 he discusses the problem of producing a low chloride content waste: “In order to achieve low chloride levels in the hydrolysis residue, an amount of water, substantially above the stoichiometric minimum, must be added so that a large amount of the input water vapor remains unreacted.” This naturally means that the hydrogen chloride produced is produced mainly as azeotropic hydrochloric acid since there is excess water.

Since hydrochloric acid is not directly reusable, Ruff then resorts to first recovering chlorosilanes by evaporation from the residue before treating the dry solid residue. Thus his process becomes very similar to Breneman. Since he recovers the chlorosilanes from the waste by evaporation there is the obvious danger of also “recovering” impurities with low boiling points such as boron trichloride, aluminum trichloride and titanium tetrachloride. In his examples the reaction times are very long with 150 minutes being required to produce a chloride content of 7%.

Thus a major deficiency in the Ruff approach of using steam is that he tries to design a single set of conditions to produce low chloride content waste and “dry” hydrogen chloride which is impossible directly because excess steam is required for a low chlorine content waste and all the steam must be consumed to produce dry hydrogen chloride. It is also difficult to do indirectly by further separation steps because the azeotropic nature of hydrochloric acid prevents formation of dry hydrogen chloride by direct separation means, although he does mention use of an absorption/desorption column which can produce hydrogen chloride and hydrochloric acid.

In the process of the new invention the provision of a fluidized bed to trap the partially hydrolyzed material allows the steaming of the partially hydrolyzed material to reduce the chloride content of the waste in a bottom zone below the injection of the chlorosilanes and the reactive drying of the resulting “wet” hydrogen chloride by the waste that is injected in excess. Thus the excess steam needed to produce low chloride content waste can be provided just prior to the exit of the solid waste and the excess halosilane waste injection can be provided above this zone to remove the excess water and produce dry hydrogen chloride.

A further deficiency of the Ruff technology is the failure to operate above 300° C. This failure is probably due to the observed fact that the rate of the hydrolysis reaction with silicon tetrachloride and other chlorosilane vapor drops as the temperature increases above 100° C. and goes to near zero at around 300° C. Thus it would seem obvious that operation above 300° C. would not be beneficial. Thus the times required for hydrolysis were very long, in one quoted example at a steam temperature of 240° C., to produce a chloride residue of 7% took 150 minutes and an azeotropic hydrochloric acid recycle flow nearly 35 times larger than the reacting steam flow.

In the process of the new invention the fact that there is a different hydrolysis mechanism above 300° C. than below 300° C., as discussed in “Theoretical Study of the Reaction Mechanism and Role of Water Clusters in the Gas-Phase Hydrolysis of SiCl4” Ignatov et al, J. Phys. Chem. A, 2003, 107, p. 8705-8713, is used to dramatically increase the rate of reaction and to produce a drier product in a shorter time with a much smaller recycle stream.

A yet further deficiency of the Ruff technology is the failure to distinguish between the extent of reaction of the various halosilanes and halides present. It is known that some materials are more resistant to hydrolysis than others and thus may make larger contributions to the excess chloride content than would be expected purely from the composition. Similarly such compounds would be unlikely to effectively compete for the small amount of residual water that are present in the drying phase and would tend to be concentrated in the partially reacted waste present in the effluent gases.

In the process of the new invention the variation in resistance to hydrolysis of the various species is ranked using the thermodynamics of the reactions and then this ranking is used to advantage in several ways.

The ranking is established by first establishing the expected reaction sets and then calculating the heat released by the reaction as is shown in the following example using chlorosilanes. Two ways of ranking are shown, one based on a molecule of reactant and one based on a molecule of water. The first ranks the reactivity in the presence of excess water and the second in a shortage of water.

Major Reactions:

SiH2Cl2(g)+2H2O(g)=SiO2+2HCl(g)+2H2(g)

SiHCl3(g)+2H2O(g)=SiO2+3HCl(g)+H2(g)

SiCl4(g)+2H2O(g)=SiO2+4HCl(g)

AlCl3(g)+1.5H2O(g)=0.5Al2O3+3HCl(g)

BCl3(g)+2H2O=HBO2+3HCl(g)

TiCl4(g)+2H2O(g)=TiO2+4HCl(g)

FeCl3(g)+1.5H2O(g)=0.5Fe2O3+3HCl(g)

2AlCl3(g)+3H2O(g)+SiO2=Al2SiO5(A)+6HCl(g)

TABLE 1

| | | | | | | | | |
|---|---|---|---|---|---|---|---|---|
| | SiH2Cl2 | SiHCl3 | SiCl4 | BCl3 | AlCl3 | AlCl3 + SiO2 | TiCl4 | FeCl3 |
| T (° C.) | kcal | kcal | kcal | kcal | kcal | kcal | kcal | kcal |

Based on one molecule of the reactant

| | | | | | | | | |
|---|---|---|---|---|---|---|---|---|
| 0.000 | −71.738 | −51.812 | −37.175 | −37.256 | −39.293 | −39.980 | −20.433 | −15.848 |
| 100.000 | −72.087 | −52.839 | −39.092 | −41.418 | −39.027 | −39.724 | −22.052 | −15.325 |
| 200.000 | −72.633 | −53.982 | −41.038 | −45.107 | −38.801 | −39.511 | −23.739 | −14.911 |
| 300.000 | −73.319 | −55.212 | −43.012 | −48.841 | −38.622 | −39.348 | −25.482 | −14.597 |
| 400.000 | −74.116 | −56.513 | −45.014 | −52.453 | −38.490 | −39.226 | −27.272 | −14.377 |
| 500.000 | −75.004 | −57.876 | −47.050 | −55.651 | −38.403 | −39.138 | −29.102 | −14.244 |
| 600.000 | −75.979 | −59.306 | −49.128 | −58.489 | −38.352 | −39.074 | −30.966 | −14.200 |
| 700.000 | −77.025 | −60.791 | −51.246 | −61.008 | −38.337 | −39.034 | −32.862 | −14.249 |
| 800.000 | −78.110 | −62.305 | −53.381 | −63.245 | −38.355 | −39.027 | −34.787 | −14.372 |
| 900.000 | −79.271 | −63.886 | −55.573 | −65.228 | −38.403 | −39.031 | −36.739 | −14.542 |
| 1000.000 | −80.462 | −65.493 | −57.785 | −66.981 | −38.481 | −39.062 | −38.715 | −14.754 |

Based on one molecule of water

| | | | | | | | | |
|---|---|---|---|---|---|---|---|---|
| 0.000 | −35.869 | −25.906 | −18.587 | −24.838 | −26.195 | −26.653 | −10.217 | −10.565 |
| 100.000 | −36.044 | −26.420 | −19.546 | −27.612 | −26.018 | −26.482 | −11.026 | −10.217 |
| 200.000 | −36.316 | −26.991 | −20.519 | −30.071 | −25.867 | −26.341 | −11.869 | −9.941 |
| 300.000 | −36.660 | −27.606 | −21.506 | −32.560 | −25.748 | −26.232 | −12.741 | −9.732 |
| 400.000 | −37.058 | −28.256 | −22.507 | −34.968 | −25.660 | −26.151 | −13.636 | −9.584 |
| 500.000 | −37.502 | −28.938 | −23.525 | −37.101 | −25.602 | −26.092 | −14.551 | −9.496 |
| 600.000 | −37.990 | −29.653 | −24.564 | −38.992 | −25.568 | −26.049 | −15.483 | −9.467 |
| 700.000 | −38.512 | −30.395 | −25.623 | −40.672 | −25.558 | −26.023 | −16.431 | −9.499 |
| 800.000 | −39.055 | −31.153 | −26.690 | −42.163 | −25.570 | −26.018 | −17.394 | −9.581 |
| 900.000 | −39.635 | −31.943 | −27.787 | −43.485 | −25.602 | −26.020 | −18.370 | −9.695 |
| 1000.000 | −40.231 | −32.747 | −28.892 | −44.654 | −25.654 | −26.041 | −19.358 | −9.836 |

Thus based on reactants the order of reactivity is SiH2Cl2: SIHCl3: BCl3: SiCl4: AlCl3 + SiO2: AlCl3: TiCl4: FeCl3
Based on one molecule of water the order of reactivity is: SiH2Cl2: BCl3: SIHCl3: AlCl3 + SiO2: AlCl3: SiCl4: TiCl4: FeCl3

One method of taking advantage of the reactivity ranking is to produce a more reactive vapor stream, containing the more reactive dihalosilane and trihalosilane, to rapidly start the reaction at the bottom and raise the bed temperature up to about 600° C. to speed up the reaction of the partially hydrolyzed residue on the granular material and to reduce the halogen content of the residue. A further method is to ensure a net removal of resistant species such as titanium tetrahalide by injecting at least one portion of the liquid/slurry waste in an area of excess steam. A yet further method is to use the more reactive dihalosilane and trihalosilane to reduce the final water content by injecting them in the low steam region above the injection zone for the resistant species. This may be done by splitting this reactive stream into two streams or the purpose of raising the bottom temperature may be done by an external heat source.

### BRIEF SUMMARY OF THE INVENTION

The primary object of the invention is to provide a better method for disposal of halosilane and halide waste from a silicon purification process that creates a safe, low volume and dry waste.

Another object of the invention is to provide a method of recovering the valuable halide content of the waste in a usable form.

Another object of the invention is to provide a method of adding hydrogen to the process to make up for losses.

A further object of the invention is to reduce the cost of operation.

Yet another object of the invention is to reduce the capital cost.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an apparatus for high temperature hydrolysis of water reactive halosilanes and halides comprising: a fluidized bed reactor operated above 300° C., the reactor containing fluidized particulate material and having at least one inlet for steam, at least one inlet for halosilanes and halides, at least one inlet for the particulate material, at least one outlet for waste solids and at least one outlet for gas and fine waste.

In accordance with a preferred embodiment of the invention, there is disclosed a process for high temperature hydrolysis of halosilanes and halides comprising the steps of: collecting and storing halosilanes and halides in a heated and agitated holding tank, heating a bed of fluidized particulate material enclosed within a reactor vessel to at least 300° C., injecting steam into the reactor vessel through at least one nozzle, feeding halosilanes from the holding tank into the reactor vessel through at least one nozzle, the halosilanes being stoichiometrically in excess to the quantity of steam, periodically or continuously removing solid waste from a first outlet in the reactor, removing effluent gases through a second outlet in the reactor, removing solids from the effluent gases in a solids removal device, condensing and separating at least a portion of the unreacted or partially reacted halosilanes and halides from the effluent gas and pumping the unreacted or partially reacted halosilanes and halides back to the holding tank while sending the effluent gases to a gas recovery system.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a schematic of the method

FIG. 2 is a cross sectional view of the apparatus.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

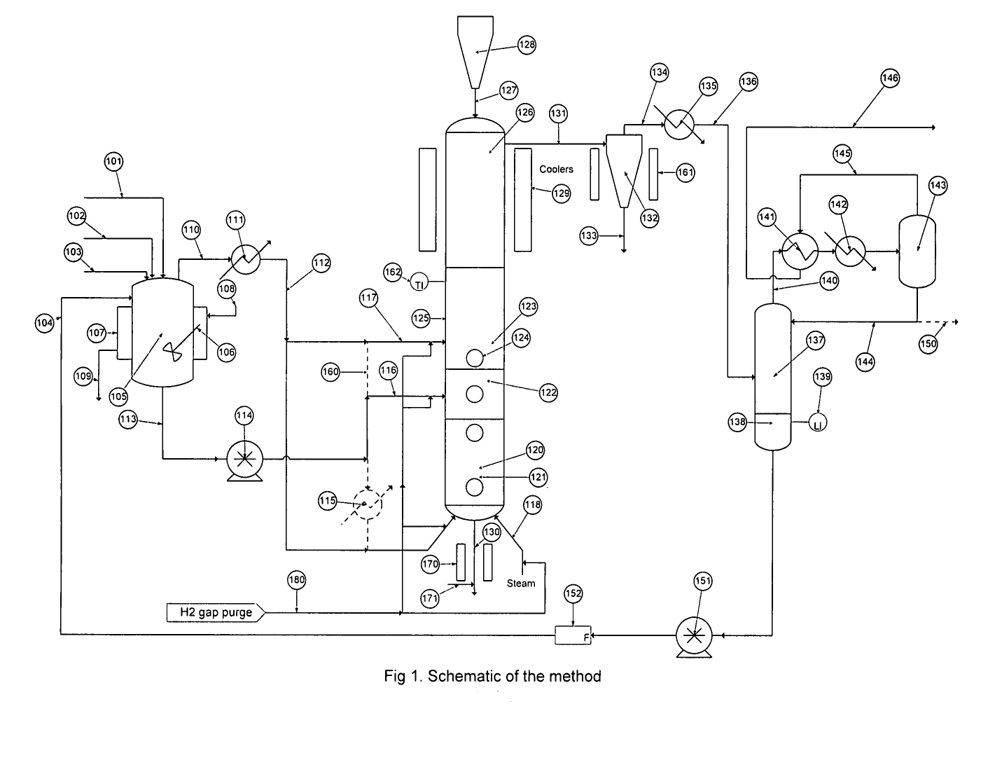

Turning to FIG. 1 there is shown a flow schematic illustrating one of several ways the hydrolysis process may be implemented.

There is a stream containing solids and various halosilanes, 101, which comes from the initial purification, a high boiling stream, 102, which comes from halosilane recovery processes, a low boiling stream, 103, which comes from trihalosilane purification and a recycle flow stream, 104, which comes from the process itself. Typically the stream containing solids and various halosilanes, 101, will contain residual spent metallurgical grade silicon and copper together with water reactive high boiling halides such as polymeric silicon halides, aluminum halide, gallium halide and indium halide. The high boiling stream, 102, will contain water reactive titanium tetrahalide, methylated halosilanes and some aluminum halide. The low boiling flow stream, 103, will contain boron trihalide, dihalosilanes and trihalosilanes, which are also water reactive. The recycle flow stream, 104, contains titanium tetrahalide, silicon tetrahalide and some partially hydrolysed halosilanes.

While the process can be applied to chlorosilanes, bromosilanes and iodosilanes, there are differences in the physical properties of the different halides which must be taken into account. Primarily, aluminum chloride is only slightly soluble in chlorosilanes and does not form a liquid phase at room pressure whereas the aluminum bromides and iodides are more soluble and do form liquid phases at atmospheric pressure. Also, the vapor pressures of bromosilanes and iodosilanes are lower than the chlorosilanes at a given temperature.

Thus for the chlorosilane design, stream 101 will have high amounts, 20-40%, by weight of solid aluminum chloride. A tank, 105, will have an agitator, 106, a jacket, 107, with a heating supply, 108, and a return stream, 109, sufficient to maintain a pressure of about 2-5 atm in the tank, 105, so that a pump, 114, is not normally needed to pump a liquid stream/slurry, 113, removed from the bottom of the tank, 105. This has the advantage of avoiding the known problems in pumping slurries. Furthermore, a solids free vapor stream, 110, is removed from the tank, 105, and can be further heated in a heater means, such as a heat exchanger or heating system, 111, to form a heated stream, 112, before being fed to the bottom of a fluidized bed reactor/granular filter, 125. This has the advantage of avoiding the difficulties in vaporizing a solids containing stream and provides a stream high in dihalosilanes and trihalosilanes which are more reactive than the tetrahalosilanes and thus are better suited to initiating the reaction with steam from a stream, 118. A possible stream, 160, is shown as a dashed line and can be used to send a liquid stream to the top section in place of or in addition to a more reactive dihalosilane and trihalosilane vapor feed 117. However, this requires splitting the solids containing stream, 113, into two streams, 116 and 160, which can lead to plugging.

For bromosilanes and iodosilanes with lower solids content it is possible to use the same approach with a higher temperature heat source for the jacket, 107, or to use the pump, 114, and a heater/vaporizer, 115, to provide the vapor flow to the bottom of the reactor. While this does not provide the concentration of the more reactive dihalosilane and trihalosilane, the bromosilanes and iodosilanes are more reactive than the equivalent chlorosilanes thus this feature is not as necessary.

It should be noted that in all cases there is a liquid feed or feeds, 116 and possibly 160, to the fluidized bed reactor/granular filter, 125. These liquid feeds serve to remove a significant portion of the exothermic heat of reaction and avoid the utility cost for vaporizing these feeds. In the event that the vapor stream 117 is used instead of the liquid feed stream 160, the heat is removed by the cold inlet temperature of the excess chlorosilanes.

There are three zones in the fluidized bed reactor/granular filter, 125, with different stoichiometric ratios of steam to halosilanes and other halides, a lower zone, 121, a middle zone, 122, and a top zone, 123. The lower zone, 121, has a high steam to halosilane ratio, the middle zone, 122, operates close to stoichiometric and the top zone, 123, has an excess of halosilanes. The fluidized bed reactor/granular filter, 125, is a fluidized bed with bubbles, 124, going up through a bed of hot solid particles, 120, which are periodically introduced through a line, 127, from a particle hopper, 128. The feeds to the bed vaporize and react to form gases and solids. The flow of the feeds is selected so that the gases generated in the bed provide a velocity that is greater than minimum fluidization velocity, U_{mf}, which is the velocity below which the particles in the reactor remain mostly fixed and is generally known to the skilled person. Above this velocity the bed starts fluidizing; that is, the bed particles move and bubbles begin to emerge. Preferably the velocity of the gases generated in the bed is one to ten times the Umf; particularly preferred is one and a half times to six times the Umf. The particles used are preferably sand with a high, >90% by wt, silica content because they are not sticky at these temperatures, are cheap and are chemically compatible to the solids generated in the reaction which are also mainly silica. It is possible to mix other materials with the particles. Thus this addition might be a convenient way to add a solid material that reacts with water. It is also possible that particles could be added that react with the hydrogen halide to form a more useful halide or halosilane. It is a particularly useful way to recycle any exit solids which do not meet specifications. These particles also function as a granular filter by trapping fine solids particles generated in the reaction and carrying them out the bottom in a solids stream, 130. A purge gas flow, 171, of hydrogen is used to carry any free water back into the reactor and prevent loss of reacting gases. An optional heater, 170, may be provided to assist in drying the exit solids. The gas bubbles merge in a disengaging space, 126, above the bed and carry some fine particles into an exit line, 131. Cooling of the gas in the reactor can occur in the disengaging zone by a cooler, 129, which can be a passive cooler where the insulation is reduced and the heat radiated from the reactor to air or an active cooler using water or other cooling fluids. Optional coolers, 161, can be provided on a solids removal device, 132; such coolers could include water jackets on the cooler and exit pipe, radiation cooling or air cooling.

The solids going into the solids removal device, 132, which is shown as a cyclone, are mainly removed out of the bottom via a solids stream, 133, and the remainder of the solids together with the gas are removed via a stream, 134. This gas and residual solids stream, 134, is cooled in a cooler, 135, to form a cooled stream, 136, and then enters a liquid gas separating device, 137, which is shown as a degassing column. The gas is then partially condensed by a liquid reflux stream, 144, which also scrubs the solids, then the remaining gas proceeds out of the degassing column, 137, via a stream 140, into a cooling means, 141, shown as a gas to gas heat exchanger, where it is cooled by a saturated gas stream, 145, then is further cooled and condensed in a cooler, 142, and enters a gas liquid separator, 143. The liquid stream, 144, proceeds back to the degassing column, 137, and it is possible to recover some of these chlorosilanes via a stream 150. The saturated gas stream, 145, leaving the gas liquid separator, 143, is reheated in the gas to gas heat exchanger, 141, to prevent condensation in the lines or downstream equipment and sent back to a recovery compressor or other recycle means via a stream 146.

One possible method of performing the important control feature of keeping the water content of the recovered hydrohalide gas low enough to directly recycle to the process is shown using a level indicator, 139, to monitor a level, 138, in the degassing column, 137, a pump, 151, and a flowmeter, 152, to ensure that there is always an excess of chlorosilanes fed to the fluidized bed reactor/granular filter, 125. The level and flow meters are monitored to ensure that there are always some chlorosilanes being recycled and that the level does not fall unduly. A further method is shown as a temperature indicator, 162, located in the top of the bed above the final injection point.

This takes advantage of the sensitivity of the temperature at this location to the ratio of chlorosilanes to steam. The temperature rises as the relative amount of steam increases because the steam is the limiting reactant; thus as the temperature rises the steam can be reduced or the halosilane flow increased.

In the mechanical design of the reactor it can be beneficial to have removable nozzle inserts. Such inserts may be more easily cooled or insulated from the heat of the reactor but the gap between the insert and the fixed nozzle on the reactor may plug with solids from the reaction. In such a case it is advisable to provide a non-reactive gas stream, 180, which is typically mainly hydrogen, and direct some gas into the gap of each nozzle to purge out the gap and prevent plugging of the gaps. These flows can be relatively small and thus not have much effect on the reactor, as shown in Table 2. In a typical example of the operation of the process, the composition, temperature and pressure of the streams are shown in Table 2.

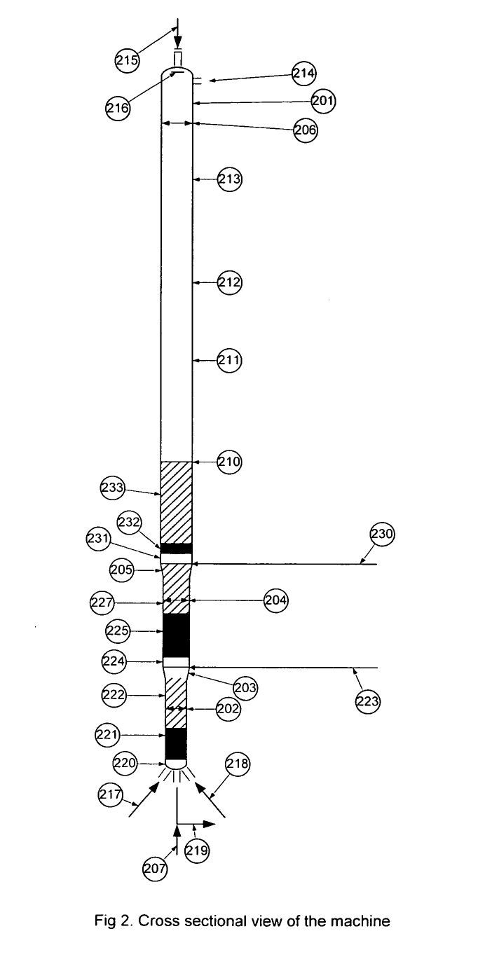

Turning now to FIG. 2 we see a cross-sectional view of the machine itself, which is a fluidized bed reactor/granular filter, showing a typical design with three reaction zones and three different reactor liner internal diameters. One important requirement for waste processing systems is flexibility in handling varying flows and this figure illustrates how use of a stepped reactor design can address this issue.

A fluidized bed reactor, 201, has three main sections, a lower section 202, which is 1 meter long and 19 cm internal diameter, a middle section, 204, which is 1 meter long and 24 cm internal diameter, and a upper section, 206, which is 5 meters long and 29 cm internal diameter and two smaller transition sections, a first transition section, 203, which connects section 202 and 204, and a second transition section, 205, which connects sections 204 and 206. An initial bed height, 210, is 3 meters and the bed expands under normal design conditions to a design condition bed expansion, 211, which is about 4 meters. The upper section of the bed is the most vigorously fluidized because of the higher flow and lower pressure so it tends to pulse into and out of the upper section, 206, but the increase in diameter reduces the pulsing without stagnating the bed. When the flow increases, the bed expands further into the upper section, 206, reaching a maximum bed expansion at maximum flow, 212, of about 5 meters with some occasional bed pulsing above that to a maximum bed pulsing location, 213, at about 6 meters which leaves about 70 cm for final disengagement before an outlet, 214, to a solids removal device, such as a cyclone. At the top a sand stream, 215, enters continuously or periodically and impacts an optional sand distributor, 216, which spreads the sand stream to aid in preheating the sand before it contacts the bed. At the bottom there is a granular solids removal stream 219. A purge gas flow, 207, of hydrogen is used to carry any free water back into the fluidized bed reactor/granular filter, 125, and prevent loss of reacting gases.

For the same example conditions discussed above we can apply thermodynamic calculations to obtain the equilibrium composition and heat and mass balances to calculate the temperature of each zone after allowing for the heat of reaction and the need to heat up the reactants. With these temperatures we can use the kinetic rate, obtained from the data in Ignatov, to calculate the time for the desired conversion of silicon tetrachloride, typically 99%, which then gives the reaction volume required for each zone. We allow 10 cm for a gas mixing zone at each gas inlet and a 20 cm mixing zone at each liquid inlet and the remainder is extra bed for granular filtration and solids reaction. Thus at the bottom where a steam stream, 217, and a vapor stream, 218, are injected, there is a 10 cm mixing zone, 220, a reaction zone 1, 221, of about 29 cm at a temperature of 666° C., followed by a granular filtration section, 222, of about 51 cm, where there is some reaction of the chloride content of the solids with excess steam at the same temperature. Then at the injection of a liquid waste stream, 223, there is a liquid mixing zone, 224, of 20 cm (10 cm below and 10 cm above the injection), a reaction Zone 2, 225, of about 42 cm at a temperature of 698° C., and a granular filtration zone, 227, of 48 cm. Finally, after the injection of a halosilane waste stream, 230, there is a gas mixing zone, 231, of 10 cm, a reaction Zone 3, 232, of 11 cm at a temperature of 670° C. and a granular filtration zone, 233, of 79 cm. The top granular filtration zone, 233, also preheats the incoming cold sand and thus has a temperature gradient from top to bottom of about 600° C. to 670° C.

In the preferred design, the reaction zone 1, 221, has an excess of steam relative to the halosilanes so the halosilanes are fully reacted and the halogen content in the solids is reduced to a low level. The reaction zone 2, 225, still has an excess of steam but it is reduced compared to reaction zone 1, 221, and declines further over the zone. In this zone the less reactive halides such as titanium are mostly reacted and there is a high conversion of halosilanes but there is some residual halogen content on the solids. Zone 3,232, is operated with an excess of halosilanes and halides in order to fully convert the steam so the exit gas is very low in water vapor. Some of these partially reacted materials will adhere to the sand and be carried down the reactor to continue the reaction. Others will be volatile enough to be carried out of the reactor in which case they are condensed in the downstream system and returned to the storage tank as discussed above in the description of FIG. 1. In the chlorosilane application there can be issues with the condensation of solids such as aluminum chloride. Thus the above referenced design, where the feed stream 230 to reaction zone 3 is a vapor stream of the same low solids composition as is used at the bottom feed stream, 218, is particularly useful for chlorosilane operation.

The operating conditions are such inside the reactor that reaction zone 1, 221, is a high steam zone, reaction zone 2, 225, has a moderate amount of steam, and reaction zone 3, 232, is a dry zone, where the water is almost completely removed, and as operation of the reactor varies the zones may move up and down the reactor. This cycling from dry to wet can be a very corrosive situation where it is difficult to form a stable passive layer on the surface of metal reactors. Thus use of a corrosion resistant layer or liner is advised for longer reactor life. Suitable materials are acid and steam resistant materials such as silica, alumina, mullite, silicon nitride, silicon carbide, refractory brick and ceramic tile.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

TABLE 2
Mass Balance of the process

| | | Stream Number | | | | | |
|---|---|---|---|---|---|---|---|
| | | 104 | 113 | 110 | 180 | 171 | 127 |
| | | Temperature (° C.) | | | | | |
| | | 32.20 | 101.80 | 101.80 | 20.00 | 20.00 | 20.00 |
| | | Pressure (atm) | | | | | |
| | | 5.00 | 5.00 | 5.00 | 4.00 | 7.00 | 1.00 |
| | | Total molar flow (kmol/h) | | | | | |
| | | 0.01 | 0.09 | 0.05 | 0.40 | 0.42 | 0.12 |
| Formula | MW g/mol | kmol/h | kmol/h | kmol/h | kmol/h | kmol/h | kmol/h |
| Gases/Liquids | | | | | | | |
| H2(g) | 2.016 | 3.11E−04 | 0.00E+00 | 6.84E−04 | 3.97E−01 | 4.19E−01 | 0.00E+00 |
| SiCl4 (g + l) | 169.898 | 6.96E−03 | 4.57E−02 | 1.50E−02 | 0.00E+00 | 0.00E+00 | 0.00E+00 |
| SiHCl3 (g + l) | 135.452 | 0.00E+00 | 9.30E−03 | 6.82E−03 | 0.00E+00 | 0.00E+00 | 0.00E+00 |
| SiH2Cl2 (g + l) | 101.007 | 0.00E+00 | 2.40E−02 | 2.76E−02 | 0.00E+00 | 0.00E+00 | 0.00E+00 |
| HCl(g) | 36.461 | 2.44E−03 | 1.46E−04 | 2.79E−03 | 2.87E−03 | 3.03E−03 | 0.00E+00 |
| AlCl3(g)¹ | 133.341 | 0.00E+00 | 4.74E−06 | 6.50E−08 | 0.00E+00 | 0.00E+00 | 0.00E+00 |
| CH4(g) | 16.043 | 0.00E+00 | 6.86E−09 | 1.31E−07 | 3.33E−05 | 3.51E−05 | 0.00E+00 |
| Si(CH3)Cl3 (g + l) | 149.479 | 0.00E+00 | 2.88E−05 | 3.20E−06 | 0.00E+00 | 0.00E+00 | 0.00E+00 |
| SiH(CH3)Cl2 (g + l) | 115.034 | 0.00E+00 | 1.24E−08 | 5.33E−09 | 0.00E+00 | 0.00E+00 | 0.00E+00 |
| TiCl4(g) | 189.712 | 0.00E+00 | 0.00E+00 | 0.00E+00 | 0.00E+00 | 0.00E+00 | 0.00E+00 |
| TiCl4(l) | 189.712 | 1.55E−04 | 5.17E−04 | 0.00E+00 | 0.00E+00 | 0.00E+00 | 0.00E+00 |
| PH3(g) | 33.997 | 0.00E+00 | 6.01E−07 | 0.00E+00 | 1.94E−07 | 2.05E−07 | 0.00E+00 |
| BCl3 (g + l) | 117.169 | 0.00E+00 | 6.64E−05 | 5.43E−05 | 0.00E+00 | 0.00E+00 | 0.00E+00 |
| H2O (g + l) | 18.015 | 1.33E−03 | 1.33E−03 | 0.00E+00 | 0.00E+00 | 0.00E+00 | 0.00E+00 |
| Solids | | | | | | | |
| Cu | 63.546 | 1.34E−08 | 2.68E−05 | 0.00E+00 | 0.00E+00 | 0.00E+00 | 0.00E+00 |
| Si | 28.086 | 4.46E−07 | 8.92E−04 | 0.00E+00 | 0.00E+00 | 0.00E+00 | 0.00E+00 |
| FeSi | 83.933 | 4.88E−08 | 9.77E−05 | 0.00E+00 | 0.00E+00 | 0.00E+00 | 0.00E+00 |
| CaCl2 | 110.986 | 8.37E−09 | 1.67E−05 | 0.00E+00 | 0.00E+00 | 0.00E+00 | 0.00E+00 |
| CrCl2 | 122.902 | 1.55E−09 | 3.10E−06 | 0.00E+00 | 0.00E+00 | 0.00E+00 | 0.00E+00 |
| AlCl3(s) | 133.341 | 0.00E+00 | 8.39E−03 | 0.00E+00 | 0.00E+00 | 0.00E+00 | 0.00E+00 |
| SiO2 | 60.085 | 5.69E−05 | 5.69E−05 | 0.00E+00 | 0.00E+00 | 0.00E+00 | 1.21E−01 |
| Al2SiO5 | 162.050 | 2.10E−06 | 2.10E−06 | 0.00E+00 | 0.00E+00 | 0.00E+00 | 0.00E+00 |
| TiO2 | 79.866 | 1.81E−07 | 1.81E−07 | 0.00E+00 | 0.00E+00 | 0.00E+00 | 0.00E+00 |
| H3BO2 | 45.833 | 9.48E−08 | 9.48E−08 | 0.00E+00 | 0.00E+00 | 0.00E+00 | 0.00E+00 |
| AlPO4 | 121.950 | 3.01E−10 | 3.01E−10 | 0.00E+00 | 0.00E+00 | 0.00E+00 | 0.00E+00 |

| | | Stream Number | | | | |
|---|---|---|---|---|---|---|
| | | 118 | 130 | 134 | 133 | 146 |
| | | Temperature (° C.) | | | | |
| | | 180.00 | 50.00 | 400.00 | 50.00 | 20.00 |
| | | Pressure (atm) | | | | |
| | | 10.00 | 4.00 | 2.00 | 2.00 | 1.88 |
| | | Total molar flow (kmol/h) | | | | |
| | | 0.25 | 0.24 | 1.35 | 0.01 | 1.32 |
| Formula | MW g/mol | kmol/h | kmol/h | kmol/h | kmol/h | kmol/h |
| Gases/Liquids | | | | | | |
| H2(g) | 2.016 | 0.00E+00 | 0.00E+00 | 9.44E−01 | 0.00E+00 | 9.34E−01 |
| SiCl4 (g + l) | 169.898 | 0.00E+00 | 0.00E+00 | 1.06E−02 | 0.00E+00 | 3.66E−03 |
| SiHCl3 (g + l) | 135.452 | 0.00E+00 | 0.00E+00 | 0.00E+00 | 0.00E+00 | 0.00E+00 |
| SiH2Cl2 (g + l) | 101.007 | 0.00E+00 | 0.00E+00 | 0.00E+00 | 0.00E+00 | 0.00E+00 |
| HCl(g) | 36.461 | 0.00E+00 | 0.00E+00 | 3.90E−01 | 0.00E+00 | 3.87E−01 |
| AlCl3(g)¹ | 133.341 | 0.00E+00 | 0.00E+00 | 0.00E+00 | 0.00E+00 | 0.00E+00 |
| CH4(g) | 16.043 | 0.00E+00 | 0.00E+00 | 1.01E−04 | 0.00E+00 | 1.00E−04 |
| Si(CH3)Cl3 (g + l) | 149.479 | 0.00E+00 | 0.00E+00 | 0.00E+00 | 0.00E+00 | 0.00E+00 |
| SiH(CH3)Cl2 (g + l) | 115.034 | 0.00E+00 | 0.00E+00 | 0.00E+00 | 0.00E+00 | 0.00E+00 |
| TiCl4(g) | 189.712 | 0.00E+00 | 0.00E+00 | 1.55E−04 | 0.00E+00 | 0.00E+00 |
| TiCl4(l) | 189.712 | 0.00E+00 | 0.00E+00 | 0.00E+00 | 0.00E+00 | 0.00E+00 |
| PH3(g) | 33.997 | 0.00E+00 | 0.00E+00 | 4.03E−07 | 0.00E+00 | 3.98E−07 |
| BCl3 (g + l) | 117.169 | 0.00E+00 | 0.00E+00 | 0.00E+00 | 0.00E+00 | 0.00E+00 |
| H2O (g + l) | 18.015 | 2.51E−01 | 0.00E+00 | 1.33E−03 | 0.00E+00 | 0.00E+00 |
| Solids | | | | | | |
| Cu | 63.546 | 0.00E+00 | 2.54E−05 | 1.34E−08 | 1.32E−06 | 0.00E+00 |
| Si | 28.086 | 0.00E+00 | 8.47E−04 | 4.46E−07 | 4.42E−05 | 0.00E+00 |
| FeSi | 83.933 | 0.00E+00 | 9.28E−05 | 4.88E−08 | 4.83E−06 | 0.00E+00 |
| CaCl2 | 110.986 | 0.00E+00 | 1.59E−05 | 8.37E−09 | 8.29E−07 | 0.00E+00 |
| CrCl2 | 122.902 | 0.00E+00 | 2.94E−06 | 1.55E−09 | 1.53E−07 | 0.00E+00 |
| AlCl3(s) | 133.341 | 0.00E+00 | 0.00E+00 | 0.00E+00 | 0.00E+00 | 0.00E+00 |
| SiO2 | 60.085 | 0.00E+00 | 2.29E−01 | 5.69E−05 | 5.63E−03 | 0.00E+00 |
| Al2SiO5 | 162.050 | 0.00E+00 | 3.99E−03 | 2.10E−06 | 2.08E−04 | 0.00E+00 |
| TiO2 | 79.866 | 0.00E+00 | 3.44E−04 | 1.81E−07 | 1.79E−05 | 0.00E+00 |
| H3BO2 | 45.833 | 0.00E+00 | 1.80E−04 | 9.48E−08 | 9.39E−06 | 0.00E+00 |
| AlPO4 | 121.950 | 0.00E+00 | 5.71E−07 | 3.01E−10 | 2.98E−08 | 0.00E+00 |

¹or dissolved solids if liquid stream
²Includes other metaloxides

1. An apparatus for high temperature hydrolysis of water reactive halosilanes and halides comprising:
a fluidized bed reactor operated above 300° C., the reactor containing fluidized particulate material and having at least one inlet for steam, at least one inlet for halosilanes and halides, at least one inlet for the particulate material, at least one outlet for waste solids and at least one outlet for gas and fine waste.

2. The process of claim 19 wherein the fluidized bed reactor has at least a first zone where the steam is present stoichiometrically in excess over the halosilanes and halides and a second zone where the halosilanes and halides are present stoichiometrically in excess over the steam.

3. The apparatus of claim 1 wherein said fluidized bed reactor has at least three zones comprising a first zone where the steam is present stoichiometrically in excess over the halosilanes and halides, a middle zone where the quantity of steam and halosilanes and halides are present in substantially stoichiometric amounts and a third zone where the halosilanes and halides are present stoichiometrically in excess over the steam.

4. The apparatus of claim 1 wherein at least one of said inlets is used to inject liquid containing halosilanes or halides.

5. The apparatus of claim 1 wherein said fluidized bed reactor has a corrosion resistant liner, comprising silica, alumina, mullite, silicon nitride, silicon carbide, refractory brick or ceramic tile, or a combination thereof.

6. The apparatus of claim 1 wherein one or more of the inlets have removable inserts.

7. A process for high temperature hydrolysis of halosilanes and halides comprising the steps of:
collecting and storing halosilanes and halides in a heated and agitated holding tank,
heating a bed of fluidized particulate material enclosed within a reactor vessel to at least 300° C.;
injecting steam into the reactor vessel through at least one nozzle,
feeding halosilanes and halides from the holding tank into the reactor vessel through at least one nozzle, the halosilanes and halides being stoichiometrically in excess to the quantity of steam
periodically or continuously removing solid waste from a first outlet in the reactor,
removing effluent gases through a second outlet in the reactor, removing solids from the effluent gases in a solids removal device, condensing and separating at least a portion of the unreacted or partially reacted halosilanes and halides from the effluent gas and
pumping the unreacted or partially reacted halosilanes and halides back to the holding tank while sending the effluent gases to a gas recovery system.

8. The process for high temperature hydrolysis of halosilanes and halides of claim 7 wherein said halosilane and halides contains at least one water reactive compound selected from the group consisting of halosilane, organohalosilane, aluminum halide, titanium halide, boron halide, manganese halide, copper halide, iron halide, chromium halide, nickel halide, indium halide, gallium halide and phosphorus halide and where the halogen element in the halosilane, organohalosilane and halides comprises chlorine, bromine or iodine.

9. The process of claim 7 wherein said fluidized material is sand, which may be provided dry or wet with water.

10. The process of claim 9 further comprising the step of adding further granular material on a continuous or periodic basis.

11. The process of claim 9 further comprising the steps of pre-mixing the sand with a water reactive or acid reactive solid waste before addition to the reactor vessel.

12. The process of claim 7 wherein said halosilane and halide compounds contain one or both of oxygen and hydrogen.

13. The process of claim 7 wherein the solids removal device is a cyclone.

14. The process of claim 7 wherein the halosilanes and halides in the effluent gas are condensing and separating using a distillation column.

15. The process of claim 7 wherein the gas recovery system is a compressor.

16. A process for converting halosilanes and halides to non-volatile, solid oxides comprising feeding one or more halosilanes and halides and feeding steam into a vessel containing a fluidized bed of inert particles, the temperature of the fluidized bed having a temperature in excess of about 300° C.

17. The process of claim 16 wherein the quantity of halosilanes and halides are stoichiometrically in excess to the quantity of steam.

18. The process of claim 16 wherein the temperature is in excess of about 600° C.

19. The process of claim 16 wherein the halosilanes and halides are fed to an upper portion of the fluidized bed and the steam is fed to a lower portion of the fluidized bed.

20. The process of claim 19 wherein said fluidized bed has at least three zones, the steam is present stoichiometrically in excess to the halosilanes and halides in a first of said zones, the steam is present in substantially a stoichiometric amount to the halosilanes and halides in a second of said zones and the halosilanes and halides are present in quantities stoichiometrically in excess of the steam in a third of said zones.

21. In a process for producing high purity silicon, a method of converting waste halosilanes and halides to solid silicon oxides comprising:
providing a fluidized bed of inert particles within a vessel, said fluidized bed maintained at a temperature in excess of about 300° C.,
injecting steam into a lower portion of the fluidized bed,
injecting at least a portion of the waste halosilanes and halides into the fluidized bed at one or more locations above the location of steam injection, said steam hydrolyzing at least some of the halosilanes and halides to form solid oxides,
removing unhydrolyzed or partially hydrolyzed halosilanes and halides from the vessel and injected at least a portion of said removed unhydrolyzed or partially hydrolyzed halosilanes and halides into the fluidized bed, said steam hydrolyzing at least some of the unhydrolyzed or partially hydrolyzed halosilanes and halides to form solid oxides,
said solid oxides being removed from the vessel and additional inert particles being added to the fluidized bed in the vessel to maintain the volume of the fluidized bed.

22. The process of claim 21 wherein the total quantity of halosilanes and halides in the vessel is stoichiometrically in excess of the quantity of steam within the vessel.

23. The process of claim 22 wherein the quantity of halosilanes and halides in the fluidized bed varies along the height of the fluidized bed such that the steam is stoichiometrically in excess of the quantity of halosilanes and halides in a lower portion of the fluidized bed and the halosilanes and halides are stoichiometrically in excess of the quantity of steam in an upper portion of the fluidized bed and the ratio of halosilanes and halides to steam decreases between the upper portion and the lower portion of the fluidized bed.

24. The process of claim 21 wherein the temperature of the fluidized bed is at a temperature in excess of about 600° C.
